(19) United States
(12) Patent Application Publication
(10) Pub. No.: US 2009/0163399 A1
(43) Pub. Date: Jun. 25, 2009

(54) Detergent Product and Process for its Preparation and Use Thereof

(75) Inventors: Fabio Corradini, Mira (IT); John Newton, Mira (IT)

Correspondence Address: NORRIS, MCLAUGHLIN & MARCUS, 875 THIRD AVE, 18TH FLOOR, NEW YORK, NY, 10022, US

(73) Assignee: Reckitt Benckiser (UK) Limited, Slough Berkshire (GB)

(21) Appl. No.: 12/300,844

(22) PCT Filed: May 11, 2007
(86) PCT No.: PCT/GB07/01752

§ 371 Date: Mar. 6, 2009

(30) Foreign Application Priority Data
May 18, 2006 (GB) 0609857.8

(51) Int. Cl. C11D 17/06

(52) U.S. Cl. 510/296

(57) ABSTRACT

A detergent product comprises a container containing a detergent composition. The container is formed by the closing of a sachet formed from a water permeable water in soluble web. The sachet comprises a flexible body of at least 10 mm in one dimension and 10 mm in another direction.

This invention relates to a detergent product, to a method for its preparation, and to its use in a washing method.

It is well known that certain metal compounds, notably calcium compounds, have a significant effect on the properties of water. “Hard” water containing a significant loading of soluble calcium and magnesium compounds form a scum with soap or detergent and may require a larger amount of detergent in order to provide an efficient clean. Scale deposits can readily form from such water, for example on heating or pH change or evaporation. These deposits can be encrustations, or watermarks left on evaporation of water droplets from, especially, a shiny surface. In addition hard water can form encrustations on fabric washed using such water giving a harsh feel to the fabric.

There have been many proposals for the removal of metal ions from aqueous solutions. In the industrial context proposals have included filter beds and polymeric filters for capturing heavy metal ions from an aqueous solution flowing within a passageway. Examples are given in EP-A-992238 and GB-A-20869564. In the domestic context sequestrants can be added to an aqueous washing solution and these can capture metal ions, such as calcium ions. Examples of such sequestrants are given in EP-A-892040.

However, consumers can be sceptical as to the benefits derived from the use of water-softening products since the benefits are not immediately obvious after a single use of the product; the benefits accumulate over time, for example preventing encrustation of heating elements or encrustations onto the fabric. Typically the water-softening product is consumed during the washing process and it is washed away, such as in the use of powder, tablets or liquid products.

In a multi-step washing process, such as that carried out by a clothes washing machine, it can be a problem that the water-softening product is discharged with the waste water, at an intermediate stage of the process, and it is not available for later stages of the washing process, such as the rinse cycle.

WO0218533 and WO0218280 describe water-softening products that are not necessarily consumed during washing processes, because they are not water-soluble, and which are too large to be washed away during any rinsing step.

In accordance with a first aspect of the present invention there is provided a detergent product comprising a container containing a detergent composition, the container being formed by the closing of a sachet formed from a water permeable water insoluble web, characterised in that the sachet comprises a flexible body of at least 10 mm in one dimension and 10 mm in another direction.

Preferably the body is such that no dimension is greater than 20 mm. Ideally each dimension is between 10-20 mm, e.g. 12 mm, 15 mm or 18 mm.

The sachet should not be able to move out of the drum, such as by entering the internal piping of the washing machine and onto the filter.

The flexibility of the body means it can deform on contact with fabric/clothing during a wash cycle so minimising damage to such fabric/clothing.

The body can also be compressed during packing so that smaller packs with less headspace can be utilised.

The body device may be configured to provide a volume adding function e.g. by being resilient so it expands on removal of compression forces. The inclusion of such a volume adding member has been shown to decrease the incidence of lodging of the device within the door seal, posting of the device in the door seal, facilitate the finding of the device after a washing operation, and can favour water flow through the device.

This in turn has a positive environmental impact by reducing the amount of packaging material required for each pack. When great numbers of packs are produced and sold, this has also positive influence on transport costs.

In a preferred embodiment the body comprises a foam material which may comprise any suitable material such as polypropylene, polyester and/or PE/EVA. The body may comprise a number of separate elements each being formed of a different material.

The body may comprise an indication means which serves to show the extent of performance of the detergent function (e.g. water softening, dye capture/transfer inhibition). A preferred example of such an indication means is a colour change within the body.

We present as a subsequent feature of the invention a process for the preparation of a detergent product, the process comprising:
a) forming an open sachet from one, two or more water-permeable water-insoluble web;
b) filling the open sachet with a detergent composition; and
c) sealing the sachet.

### Optional Steps

Preferably the process includes the step of cutting the web(s) to form the open or closed sachet. Most preferably the process includes the step of cutting the closed sachet to form the water-softening product.

A series of additional steps may be performed, in any order and combination; including:
a) distributing evenly the detergent composition through the sachet;
b) fixing the detergent composition to itself and/or the wall(s) of the sachet;
c) packaging the sachet into a moisture impermeable package.

Alternatively a method in accordance with the invention may be a manual method, for example using a hand-cloth or mop, and an open vessel, for example a bucket or bowl. Thus, the cleaning method could be a method of cleaning a hard surface, for example a window, a tiled surface, shower screen, dirty tableware and kitchenware, a sanitaryware article, for example a lavatory, wash basin or sink, a car (which we regard as a “household article” within the terms of this invention) or a kitchen worktop.

We further present a method of treating laundry in a washing machine comprising using the product of the invention in a ware washing machine.

In preferred embodiment the detergent composition is a water-softening composition.

Hence we further present a method of softening water comprising contacting hard water with a product as defined herein.

A method of softening water may be a method used in a ware washing machine, for example a clothes washing machine or a dishwashing machine. Preferably the product is able to work through the wash and the rinse cycle of the machine; or only in the rinse cycle, or just in the washing cycle.

### Product Features

By water permeable we mean that the material allows water to pass through, under the conditions in which the product is used. Suitably the material has an air permeability of at least 1000 l/m²/s at 100 Pa according to DIN EN ISO 9237. In addition the web must not be so permeable that it is not able to hold a granular water-softening composition (e.g. greater than 150 microns).

A closed sachet intended for use in a ware washing machine must resist a laundry wash cycle (2 h wash/rinse/spin cycle, 95° C., spinning at 1600 rpm) without opening.

Preferably the detergent composition is in the form of a compact, preferably firm, “cake” inside the sachet. Preferably, the cake is spread across the interior of the sachet. Ideally, the cake is also attached to either or both inside walls of the sachet, as a “sandwich”. Preferably during the wash, the cake breaks to create a loose amount of granular insoluble materials that can move freely inside the sachet, like in a “tea bag”, that allows the permeating water to be exposed to the entire surface area of the contents of the sachet.

The product could be discarded after use, or it could be regenerated when certain water-softening agents are used, for example cation exchange resins by using sodium chloride to effect ion exchange, and re-used.

The sachet is preferably flat, i.e. with one dimension, the thickness of the sachet, at least 5 times smaller preferably at least 10 times smaller, ideally at least 30 times smaller than the other two, the width and the length of the sachet (which are the same as each other, corresponding to the diameter of the sachet, should it be circular in plan). Preferred thickness are in the range of 10-20 mm, e.g. 10 mm, 15 mm or 20 mm.

Preferably the sachet covers a surface (i.e. the product of width and length (when the sachet is rectangular) of between 80 to 300 cm², ideally 100 to 200 cm². Preferred lengths/widths are in the range of 5-30 cm, e.g. 6 cm, 10 cm, 12 cm, 15 cm, 20 cm, 25 cm or 30 cm.

The sachet may be placed with the items to be washed in an automatic washing machine.

Alternatively the sachet may pack into the flow pathway for the rinse or wash water of a ware washing machine such that the water is compelled to flow through it.

The detergent composition may comprise an admixture of detergent actives.

Surfactants may be present in the composition. The surfactant is, for example, an anionic or nonionic surfactant or mixture thereof. The nonionic surfactant is preferably a surfactant having a formula RO(CH₂CH₂O)nH wherein R is a mixture of linear, even carbon-number hydrocarbon chains ranging from C₁₂H₂₅ to C₁₆H₃₃ and n represents the number of repeating units and is a number of from about 1 to about 12. Examples of other non-ionic surfactants include higher aliphatic primary alcohol containing about twelve to about 16 carbon atoms which are condensed with about three to thirteen moles of ethylene oxide.

Other examples of nonionic surfactants include primary alcohol ethoxylates (available under the Neodol tradename from Shell Co.), such as C₁₁ alkanol condensed with 9 moles of ethylene oxide (Neodol 1-9), C₁₂₋₁₃ alkanol condensed with 6.5 moles ethylene oxide (Neodol 23-6.5), C₁₂₋₁₃ alkanol with 9 moles of ethylene oxide (Neodol 23-9), C₁₂₋₁₅ alkanol condensed with 7 or 3 moles ethylene oxide (Neodol 25-7 or Neodol 25-3), C₁₄₋₁₃ alkanol condensed with 13 moles ethylene oxide (Neodol 45-13), C₉₋₁₁ linear ethoxylated alcohol, averaging 2.5 moles of ethylene oxide per mole of alcohol (Neodol 91-2.5), and the like.

Other examples of suitable nonionic surfactants include ethylene oxide condensate products of secondary aliphatic alcohols containing 11 to 18 carbon atoms in a straight or branched chain configuration condensed with 5 to 30 moles of ethylene oxide. Examples of commercially available non-ionic detergents of the foregoing type are C₁₁₋₁₅ secondary alkanol condensed with either 9 moles of ethylene oxide (Tergitol 15-S-9) or 12 moles of ethylene oxide (Tergitol 15-S-12) marketed by Union Carbide.

Other examples of linear primary alcohol ethoxylates are available under the Tomadol tradename such as, Tomadol 1-7, a C₁₁ linear primary alcohol ethoxylate with 7 moles EO; Tomadol 25-7, a C₁₂₋₁₅ linear primary alcohol ethoxylate with 7 moles EO; Tomadol 45-7, a C₁₄₋₁₅ linear primary alcohol ethoxylate with 7 moles EO; and Tomadol 91-6, a C₉₋₁₁ linear alcohol ethoxylate with 6 moles EO.

Other nonionic surfactants are amine oxides, alkyl amide oxide surfactants.

Preferred anionic surfactants are frequently provided as alkali metal salts, ammonium salts, amine salts, aminoalcohol salts or magnesium salts. Contemplated as useful are sulfate or sulfonate compounds including: alkyl benzene sulfates, alkyl sulfates, alkyl ether sulfates, alkylamidoether sulfates, alkylaryl polyether sulfates, monoglyceride sulfates, alkylsulfonates, alkylamide sulfonates, alkylarylsulfonates, olefinsulfonates, paraffin sulfonates, alkyl sulfosuccinates, alkyl ether sulfosuccinates, alkylamide sulfosuccinates, alkyl sulfosuccinamate, alkyl sulfoacetates, alkyl phosphates, alkyl ether phosphates, acyl sarconsinates, acyl isethionates, and N-acyl taurates. Generally, the alkyl or acyl radical in these various compounds comprise a C₁₂₋₂₀ carbon chain.

Other surfactants which may be used are alkyl naphthalene sulfonates and oleoyl sarcosinates and mixtures thereof.

Examples of suitable bleaches are oxygen bleaches. Suitable level of oxygen bleaches is in the range from 0.01 to 90% wt. As used herein active oxygen concentration refers to the percentage concentration of elemental oxygen, with an oxidation number zero, that being reduced to water would be stoichiometrically equivalent to a given percentage concentration of a given peroxide compound, when the peroxide functionality of the peroxide compound is completely reduced to oxides. The active oxygen sources increase the ability of the compositions to remove oxidisable stains, to destroy malodorous molecules and to kill germs.

The concentration of available oxygen can be determined by methods known in the art, such as the iodimetric method, the permanganometric method and the cerimetric method. Said methods and the criteria for the choice of the appropriate method are described for example in “Hydrogen Peroxide”, W. C. Schumo, C. N. Satterfield and R. L. Wentworth, Reinhold Publishing Corporation, New York, 1955 and “Organic Peroxides”, Daniel Swern, Editor Wiley Int. Science, 1970.

Suitable organic and inorganic peroxides for use in the compositions according to the present invention include diacyl and dialkyl peroxides such as dibenzoyl peroxide, dilauroyl peroxide, dicumyl peroxide, persulphuric acid and mixtures thereof.

Suitable preformed peroxyacids for use in the compositions according to the present invention include diperoxydode-candioic acid DPDA, magnesium perphthalatic acid, perlauric acid, perbenzoic acid, diperoxyazelaic acid and mixtures thereof. Peroxygen bleaching actives useful for this invention are: percarbonates, perborates, peroxides, peroxyhydrates, persulfates. A preferred compound is sodium percarbonate and especially the coated grades that have better stability. The percarbonate can be coated with silicates, borates, waxes, sodium sulfate, sodium carbonate and surfactants solid at room temperature.

Optionally, the composition may comprise from 0.1% to 30%, preferably from 2% to 20% of peracid precursors, i.e. compounds that upon reaction with hydrogen peroxide product peroxyacids. Examples of peracid precursors suitable for use in the present invention can be found among the classes of anhydrides, amides, imides and esters such as acetyl triethyl citrate (ATC) described for instance in EP 91 87 0207, tetra acetyl ethylene diamine (TAED), succinic or maleic anhydrides.

The composition may comprise a builder or a combination of builders, for example in an amount of from 0.01 to 50% wt, preferably from 0.1 to 20% wt.

### Examples of Builders Are Described Below

the parent acids of the monomeric or oligomeric polycarboxylate chelating agents or mixtures therefore with their salts, e.g. citric acid or citrate/citric acid mixtures are also contemplated as useful builder components.
borate builders, as well as builders containing borate-forming materials than can produce borate under detergent storage or wash conditions can also be used.
iminosuccinic acid metal salts
polyaspartic acid metal salts.
ethylene diamino tetra acetic acid and salt forms.
water-soluble phosphonate and phosphate builders are useful for this invention. Examples of phosphate buiders are the alkali metal tripolyphosphates, sodium potassium and ammonium pyrophosphate, sodium and potassium and ammonium pyrophosphate, sodium and potassium orthophosphate sodium polymeta/phosphate in which the degree of polymerisation ranges from 6 to 21, and salts of phytic acid. Specific examples of water-soluble phosphate builders, are the alkali metal tripolyphosphates, sodium potassium and ammonium pyrophosphate, sodium and potassium and ammonium pyrophosphate, sodium and potassium orthophosphate, sodium polymeta/phosphate in which the degree of polymerization ranges from 6 to 21, and salts of phytic acid. Such polymers include the polycarboxylates containing two carboxy groups include the water-soluble salts of succinic acid, malonic acid, (ethylenedioxy) diacetic acid, maleic acid, diglycolic acid, tartaric acid, tartronic acid and fumaric acid, as well as the ether carboxylates and the sulfinyl carboxylates.

Polycarboxylates containing three carboxy groups include, in particular, water-soluble citrates, aconitrates and citraconates as well as succinate derivates such as the carboxymethloxysuccinates described in GB-A-1,379,241, lactoxysuccinates described in GB-A-1,389,732, and aminosuccinates described in NL-A-7205873, and the oxypolycarboxylate materials such as 2-oxa-1,1,3-propane tricarboxylates described in GB-A-1,387,447.

Polycarboxylate containing four carboxy groups include oxydisuccinates disclosed in GB-A-1,261,829, 1,1,2,2-ethane tetracarboxylates, 1,1,3,3-propane tetracarboxylates and 1,1,2,3-propane tetracarobyxlates. Polycarboxylates contining sulfo substituents include the sulfosuccinate derivatives disclosed in GB-A-1,398,421, GB-A-1,398,422 and U.S. Pat. No. 3,936,448, and the sulfonated pyrolsed citrates described in GB-A-1,439,000.

Alicylic and heterocyclic polycarboxylates include cyclopentane-cis,cis,cis-tetracarboxylates, cyclopentadienide pentacarboxylates, 2,3,4,5,6-hexane-hexacarboxylates and carboxymethyl derivates of polyhydric alcohols such as sorbitol, mannitol and xylitol. Aromatic polycarboxylates include mellitic acid, pyromellitic acid and phthalic acid derivatives disclosed in GB-A-1,425,343.

Of the above, the preferred polycarboxylates are hydroxycarboxylates containing up to three carboxy groups per molecule, more particularly citrates.

Suitable polymers include the water soluble monomeric polycarboxylates, or their acid forms, homo or copolymeric polycarboxylic acids or their salts in which the polycarboxylic acid comprises at least two carboxylic radicals separated from each other by not more than two carbon atoms, carbonates, bicarbonates, borates, phosphates, and mixtures of any of thereof.

The carboxylate or polycarboxylate builder can be monomeric or oligomeric in type although monomeric polycarboxylates are generally preferred for reasons of cost and performance.

Suitable carboxylates containing one carboxy group include the water soluble salts of lactic acid, glycolic acid and ether derivatives thereof. Polycarboxylates containing two carboxy groups include the water-soluble salts of succinic acid, malonic acid, (ethylenedioxy) diacetic acid, maleic acid, diglycolic acid, tartaric acid, tartronic acid and fumaric acid, as well as the ether carboxylates and the sulfinyl carboxylates. Polycarboxylates containing three carboxy groups include, in particular, water-soluble citrates, aconitrates and citraconates as well as succinate derivates such as the carboxymethloxysuccinates described in GB-A-1,379,241, lactoxysuccinates described in GB-A-1,389,732, and aminosuccinates described in NL-A-7205873, and the oxypolycarboxylate materials such as 2-oxa-1,1,3-propane tricarboxylates described in GB-A-1,387,447.

Polycarboxylate containing four carboxy groups include oxydisuccinates disclosed in GB-A-1,261,829, 1,1,2,2-ethane tetracarboxylates, 1,1,3,3-propane tetracarboxylates and 1,1,2,3-propane tetracarboxylates. Polycarboxylates contining sulfo suibstituents include the sulfosuccinate derivatives disclosed in GB-A-1,398,421, GB-A-1,398,422 and U.S. Pat. No. 3,936,448, and the sulfonated pyrolsed citrates described in GB-A-1,439,000.

Alicylic and heterocyclic polycarboxylates include cyclopentane-cis,cis,cis-tetracarboxylates, cyclopentadienide pentacarboxylates, 2,3,4,5,6-hexane-hexacarboxylates and carboxymethyl derivates of polyhydric alcohols such as sorbitol, mannitol and xylitol. Aromatic polycarboxylates include mellitic acid, pyromellitic acid and phthalic acid derivatives disclosed in GB-A-1,425,343.

Of the above, the preferred polycarboxylates are hydroxycarboxylates containing up to three carboxy groups per molecule, more particularly citrates.

More preferred polymers are homopolymers, copolymers and multiple polymers of acrylic, fluorinated acrylic, sulfonated styrene, maleic anhydride, metacrylic, isobutylene, styrene and ester monomers.

Examples of these polymers are Acusol supplied from Rohm & Haas, Syntran supplied from Interpolymer and Versa and Al-cosperse series supplied from Alco Chemical, a National Starch & Chemical Company.

The parent acids of the monomeric or oligomeric polycarboxylate chelating agents or mixtures therefore with their salts, e.g. citric acid or citrate/citric acid mixtures are also contemplated as useful builder components.

In the context of the present application it will be appreciated that builders are compounds that sequester metal ions associated with the hardness of water, e.g. calcium and magnesium, whereas chelating agents are compounds that sequester transition metal ions capable of catalysing the degradation of oxygen bleach systems. However, certain compounds may have the ability to do perform both functions.

Suitable chelating agents to be used herein include chelating agents selected from the group of phosphonate chelating agents, amino carboxylate chelating agents, polyfunctionally-substituted aromatic chelating agents, and further chelating agents like glycine, salicylic acid, aspartic acid, glutamic acid, malonic acid, or mixtures thereof. Chelating agents when used, are typically present herein in amounts ranging from 0.01% to 50% wt of the total composition and preferably from 0.05% to 10% wt.

Suitable phosphonate chelating agents to be used herein may include ethydronic acid as well as amino phosphonate compounds, including amino alkylene poly (alkylene phosphonate), alkali metal ethane 1-hydroxy diphosphonates, nitrilo trimethylene phosphonates, ethylene diamine tetra methylene phosphonates, and diethylene triamine penta methylene phosphonates. The phosphonate compounds may be present either in their acid form or as salts of different cations on some or all of their acid functionalities. Preferred phosphonate chelating agents to be used herein are diethylene triamine penta methylene phosphonates. Such phosphonate chelating agents are commercially available from Monsanto under the trade name DEQUEST™.

Polyfunctionally-substituted aromatic chelating agents may also be useful in the compositions herein. See U.S. Pat. No. 3,812,044. Preferred compounds of this type in acid form are dihydroxydisulfobenzenes such as 1,2-dihydroxy-3, 5-disulfobenzene.

A preferred biodegradable chelating agent for use herein is ethylene diamine N,N′-disuccinic acid, or metal/ammonium salts thereof. Ethylenediamine N,N′-disuccinic acids is, for instance, commercially available under the tradename ssEDDS™ from Palmer Research Laboratories.

Suitable amino carboxylates include ethylene diamine tetra acetates, diethylene triamine pentaacetates, diethylene triamine pentaacetate (DTPA), N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) MGDA, in their acid form, or in their alkali metal, ammonium, and substituted ammonium salt forms. Particularly suitable amino carboxylates to be used herein are DTPA, propylene diamine tetracetic acid which is commercially available from BASF under the trade name Trilon FS™.

Solvents can be used for present invention at levels of 0.01 to 30% wt, more preferred level is between 0.1 and 20%, more preferred between 0.1 and 10%. The solvent constituent may include one or more alcohol, glycol, acetate, ether acetate, glycerol, polyethylene glycol with molecular weight ranging from 200 to 1000, silicones or glycol ethers. Exemplary alcohols useful in the compositions of the invention include C₂₋₈ primary and secondary alcohols which may be straight chained or branched, preferably pentanol and hexanol. Exemplary silicones useful in the compositions of the invention include cyclic silicones (cyclomethicones) like DC 244 Fluid, DC 245 Fluid, DC 246 Fluid, DC 344 Fluid; silicone polyether like DC 190 and DC 193.

Preferred solvents for the invention are glycol ethers and examples include those glycol ethers having the general structure. Preferred solvents for the invention are glycol ethers and examples include those glycol ethers having the general structure Ra-O—[CH₂—CH(R)—(CH₂)—O]ₙ—H, wherein Ra is C₁₋₂₀ alkyl or alkenyl, or a cyclic alkane group of at least 6 carbon atoms, which may be fully or partially unsaturated or aromatic; n is an integer from 1 to 10, preferably from 1 to 5; each R is selected from H or CH₃; and a is the integer 0 or 1. Specific and preferred solvents are selected from propylene glycol methyl ether, dipropylene glycol methyl ether, tripropylene glycol methyl ether, propylene glycol n-propyl ether, ethylene glycol n-butyl ether, diethylene glycol n-butyl ether, diethylene glycol methyl ether, propylene glycol, ethylene glycol, isopropanol, ethanol, methanol, diethylene glycol monoethyl ether acetate, and particularly useful are, propylene glycol phenyl ether, ethylene glycol hexyl ether and diethylene glycol hexyl ether.

The composition may comprise an enzyme. Example of suitable enzymes are proteases, modified proteases stable in oxidisable conditions, amylases and lipases.

The composition may comprise an insecticide. Suitable insecticides may be chosen from a wide range of active ingredients, both natural and synthetic.

Examples of suitable insecticide ingredients include pyre-throids, neonicotinoids (e.g. imidacloprid, thiamethoxam), avermectins, spinosyns (e.g. spinosad), hydramethylnon, fluorinated sulfluoramides, organophosphates including diazinon and chlorpyrifos, pyrazoles such as fipronil, chlorfenapyr, indoxacarb, borates, benzoylphenyl ureas, carbamates and hydrazones. A preferred insecticide in the present invention is chlorpyrifos.

Suitable film-forming polymers include, acrylic polymers (e.g. modified acrylic polymers), fluorine based polymers (e.g. PTFE), polyurethane and silicones.

Additionally, optional ingredients may be included. Suitable optional ingredients comprise optical brighteners, fragrances, dyes, dye transfer inhibitors, granulation aids, anti-caking agents.

Preferably the detergent composition is a stain-treatment composition. Such a composition can be used in addition to a conventional detergent composition to provide enhanced treatment of, for example, certain stains.

### Stain Treatment Composition

A preferred stain treatment composition is shown below:-

| Formula 100% | % |
|---|---|
| Na percarbonate coated | 55.00 |
| Na Bicarbonate | 20.00 |
| Na sulphate | 17.40 |
| AS needles - anionic surfactant | 3.68 |
| Na N-Lauryl Sarcosinate-anionic surfactant | 0.48 |
| Ethoxylated alcohol C13-C15 7EO | 0.50 |
| Na Xilen sulph.-Hydrotope | 0.46 |
| Purafect VV-G-OX | 0.30 |
| PVP G | 0.50 |
| CMC | 0.34 |
| Enzyme Cellulase 0.7 | 0.20 |
| TAED white | 0.46 |
| VN47 (Fragrance) | 0.10 |
| Water & minors | 0.58 |
| Total | 100.00 |

In a further preferred embodiment the detergent composition is a water-softening-composition.

### Water-Softening Composition

The water-softening composition may contain one or more water-softening agents.

Preferably at least one water-softening agent is present which is substantially water-insoluble.

By substantially water-insoluble water-softening agent we mean an agent, more than 50% wt, preferably at least 70% wt, more preferably at least 85% wt and most preferably at least 95% wt, and optimally 100% wt, of which is retained in the product, when the product is used under the most rigorous conditions for which it is intended (90° C.).

The composition could contain a water-soluble solid agent or a dispersible solid agent that is not water-soluble but which can pass through the walls of the container when immersed in water. Such a water-soluble or dispersible solid agent could be, for example, any possible component of compositions with which the product can be used.

Preferably the total amount of water-softening composition is between 5 and 25 g, ideally between 7 and 20 g.

The composition is preferably substantially free of any surfactant and/or a source of active oxygen (whether water-soluble or not). In one embodiment the composition is preferably substantially free of phosphonate compounds, and more preferably is substantially free of any phosphorous-containing compounds. However other embodiments could contain one or more such compounds. By substantially free we mean less than 20% wt, 10% wt, 5% wt, less than 2% wt, less than 1% wt, ideally less than 0.5% wt of such compounds relative to the total weight of the water-softening composition.

Preferably the water-softening composition is of particulate form, or formed from a particulate material. Preferably the particle size distribution of the water-softening composition is <0.2% at <100 microns and/or <0.1% at >2 mm.

Within the water-softening composition may be present an adhesive to fix the composition itself to form a cake and/or to one, at least, of the walls of the sachet, such as, polyethylene, EVA (preferably low melting point), polyamides, polyurethanes, epoxy or acrylic resins added in particulate (e.g. powder or granular) form within the composition. Subsequent heating (by convection or conduction or irradiation, especially with IR or UV) activates the binder within the composition and causes it to form a cake with the product. Preferably through the agency of the melted and cooled/set binder the cake is adhered to both sheets of the sachet.

### Water-Insoluble Water-Softening Agent

A water-insoluble agent could comprise polymeric bodies. Suitable forms include beads and fibres. Examples include polyacrylic acid and algins. The water-insoluble agent could alternatively be an inorganic material, for example a granular silicate or zeolite which is retained by the product walls.

Preferably, water-insoluble water-softening agent is present in the water-softening composition in an amount of more than 1%, 5%, 10%, 20%, 30%, 40%, 50%, 60%, 70%, 80%, 90% and 95% wt thereof. Desirable maximum amounts are less than 95%, 90%, 80%, 70%, 60%, 50%, 40%, 30%, 20% and 10% wt, based on the total weight of the water-softening composition. A preferred range is 10-60%, more preferably 20-50%, most preferably 30-40%.

Sequestrant side chains may be grafted onto water-insoluble bodies (such as polymeric bodies), for example using the well-known techniques of radiation grafting or chemical grafting. Radiation grafting is described in WO 94/12545. Chemical grafting is described in GB 2086954A. Alternatively for certain side chains the polymeric bodies may be fabricated (for example melt spun) already bearing the sequestrant side-chains, as described in EP 486934A. In yet other embodiments polymeric bodies not bearing sequestrant side chains may be coated with material which has the side chains. The polymeric bodies may, in effect, be regarded as carrying the side chains by mechanical adhesion. Alternatively they may attach by cross-linking, as described in EP 992283A.

Preferably sequestrant side chains are any side-chains which can be carried by polymeric bodies, and which are able to bind calcium (and preferably other) ions, and whose effectiveness in doing that is not substantially diminished by a cleaning agent. Suitable calcium-binding side-chains include residues of acids, for example of acrylic or methacrylic acid, or carboxylic acids, or of sulphonic acids, or of phosphonic acids. Residues of organic acids are preferred. Particularly preferred are residues of methacrylic or, especially, acrylic acid.

Alternative calcium-binding side chains of polymeric bodies may include amino groups, quaternary ammonium salt groups and iminodicarboxyl groups —N{ (CH₂)ₙCOOH}₂, where n is 1 or 2.

Further suitable calcium-binding side chains of polymeric bodies may include acyl groups as described in EP 984095A. These have the formula

—C(O)—X(V)(Z)(M) or —C(O)—X(V)(Z)(S-M′)

where X represents a residue in which one carboxyl group is eliminated from a monocarboxylic acid or dicarboxylic acid;
V represents hydrogen or a carboxyl group;
M represents hydrogen; or

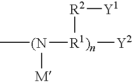

wherein R¹ represents a residue in which one hydrogen is eliminated from a carbon chain in an alkylene group, R² represents a direct bond or an alkylene group, Y¹ and Y² are the same or different and each represents hydrogen, a carboxyl group, an amino group, a hydroxy group or a thiol group, n is an integer of 1 to 4, M′ represents hydrogen or

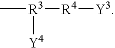

wherein R³ represents a residue in which one hydrogen is eliminated from a carbon chain in an alkylene group, R⁴ represents a direct bond or an alkylene group, Y³ and Y⁴ are the same or different and each represents hydrogen, a carboxyl group, an amino group, a hydroxy group or a thiol group; and Z represents hydrogen or has the same meaning as that of M.

Such side chains are preferably carried by polymeric fibres selected from polyolefins, poly(haloolefins), poly(vinylalcohol), polyesters, polyamides, polyacrylics, protein fibres and cellulosic fibres (for example cotton, viscose and rayon). Polyolefins are especially preferred, particularly polyethylene and polypropylene.

When side chains are grafted onto the base polymeric bodies a preferred process is one using irradiation, in an inert atmosphere, with immediate delivery to irradiated bodies of acrylic acid. Preferably the radiation is electron beam or gamma radiation, to a total dose of 10-300 kGy, preferably 20-100 kGy. The acrylic acid is preferably of concentration 20-80 vol %, in water, and the temperature at which the acrylic acid is supplied to the irradiated polymeric bodies is preferably an elevated temperature, for example 30-80° C. Preferably the base polymeric bodies are polyethylene, polypropylene or cellulosic fibres.

In a preferred feature the water-insoluble agent comprises ion exchange resin, preferably cation exchange resin. Cation exchange resins may comprise strongly and/or weakly acidic cation exchange resin. Further, resins may comprise gel-type and/or macroreticular (otherwise known as macroporous)-type acidic cation exchange resin. The exchangeable cations of strongly acidic cation exchange resins are preferably alkali and/or alkaline earth metal cations, and the exchangeable cations of weakly acidic cation exchange. resins are preferably H⁺ and/or alkali metal cations.

Suitable strongly acidic cation exchange resins include styrene/divinyl benzene cation exchange resins, for example, styrene/divinyl benzene resins having sulfonic functionality and being in the Na⁺ form such as Amberlite 200, Amberlite 252 and Duolite C26, which are macroreticular-type resins, and Amberlite IR-120, Amberlite IR-122, Amberlite IR-132, Duolite C20 and Duolite C206, which are gel-type resins. Suitable weakly acidic cation exchange resins include acrylic cation exchange resins, for example, Amberlite XE-501, which is a macroreticular-type acrylic cation exchange resin having carboxylic functionality and being in the H⁺ form, and Amberlite DP1 which is a macroreticular-type methacrylic/divinyl benzene resin having carboxylic functionality and being in the Na³⁰ form.

Other forms of water-insoluble ion exchange agents can be used—such agents include alkali metal (preferably sodium) aluminosilicates either crystalline, amorphous or a mixture of the two. Such aluminosilicates generally have a calcium ion exchange capacity of at least 50 mg CaO per gram of aluminosilicate, comply with a general formula:

0.8-1.5 Na₂O.Al₂O₃.0.8-6 SiO2

and incorporate some water. Preferred sodium aluminosilicates within the above formula contain 1.5-3.0 SiO₂ units. Both amorphous and crystalline aluminosilicates can be prepared by reaction between sodium silicate and sodium aluminate, as amply described in the literature.

Suitable crystalline sodium aluminosilicate ion-exchange detergency builders are described, for example, in GB 1429143 (Procter & Gamble). The preferred sodium aluminosilicates of this type are the well known commercially available zeolites A and X, and mixtures thereof. Also of interest is zeolite P described in EP 384070 (Unilever).

Another class of compounds are the layered sodium silicate builders, such as are disclosed in U.S. Pat. No. 4, 464, 839 and U.S. Pat. No. 4, 820, 439 and also referred to in EP-A-551375.

These materials are defined in U.S. Pat. No. 4, 820, 439 as being crystalline layered, sodium silicate of the general formula

NaMSiₓO₂ₓ₊₁.YH₂O

where
M denotes sodium or hydrogen,
x is from 1.9 to 4 and y is from 0 to 20.

Quoted literature references describing the preparation of such materials include Glastechn. Ber. 37, 194-200 (1964), Zeitschrift für Kristallogr. 129, 396-404 (1969), Bull. Soc. Franc. Min. Crist., 95, 371-382 (1972) and Amer. Mineral, 62, 763-771 (1977). These materials also function to remove calcium and magnesium ions from water, also covered are salts of zinc which have also been shown to be effective water-softening agents.

In principle, however, any type of insoluble, calcium-binding material can be used.

Preferably the water-insoluble water-softening agent is also able to bind magnesium ions as well as calcium ions.

### Water-Soluble Water-Softening Agents

A water-soluble water-softening agent may be present in the water-softening composition in an amount of more than 1%, 5%, 10%, 20%, 30%, 40%, 50%, 60%, 70%, 80%, 90% and 95% wt thereof. Desirable maximum amounts are less than 95%, 90%, 80%, 70%, 60%, 50%, 40%, 30%, 20% and 10% wt, based on the total weight of the water-softening composition. A preferred range is 20-80%, more preferably 40-70%, and most preferably 50-60%.

By the term “water-soluble” we include agents that are water dispersible. Such agents include
1) Ion capture agents—agents which prevent metal ions from forming insoluble salts or reacting with surfactants, such as polyphosphate, monomeric polycarbonatesi such as citric acid or salts thereof.
   2) Anti-nucleating agents—agents which prevent seed crystal growth, such as polycarbonate polymers, such as polyacrylates, acrylic/maleic copolymers, phosphonates, and acrylic phosphonates and sulfonates.
   3) Dispersing agents—agents that keep crystals suspended in solution, such as polyacrylate polymers.

### Preferred Water-Softening Compositions

Preferred water-softening compositions contain at least one of the following:
(1) citric acid, preferably 1-30% wt, especially 5-20% wt; and
(2) trisodium citrate, preferably 5-80% wt, especially 40-60% wt.

Preferably both such compounds are present, within the ranges stated.

Preferred water-softening compositions may contain at least one of
(3) acrylic acid copolymer or, preferably, homopolymer, preferably 5-60% wt, especially 20-40% wt;
(4) cationic ion exchange resin, preferably 1-30% wt, especially 3-10% wt; and
(5) esterquat, preferably 0.1-5% wt, especially 0.2-2% wt;

Preferred water-softening compositions may contain
(6) fusible/re-settable binder, preferably 5-30% wt, especially 8-20% wt.

In each case the amount stated is based on the total weight of the water-softening composition, subject preferably to the total of such compounds (1) to (6) as are present being substantially 100% wt of the water-softening composition (as is preferred) or less (when there are other components present)—but preferably at least 80% of the water-softening composition. A preferred water-softening composition contains:

component (1) or (2), most preferably (1) and (2);

at least one of component (3) or (4) or (5), more preferably (3) and (4), or (4) and (5), or (3) and (5), most preferably (3) and (4) and (5); and component (6).

### Forming an Open Sachet

Sachet forming can be done in an horizontal or in a vertical plane, either from a single roll of water permeable water-insoluble material that is folded to form the walls of the sachet or from two or more rolls of water permeable water insoluble material that are joined together to form the walls of the sachet.

Machine assemblies for sachet forming, filling and sealing can be sourced from, VAI, IMA, Fuso for vertical machines; Volpack, Iman Pack for horizontal sachet machines; Rossi, Optima, Cloud for horizontal pod machines.

### Filling the Open Sachet

The open sachet is preferably configured as a pocket or pouch, preferably sealed or otherwise closed on three edges, and which can be filled through an edge, for example the fourth, open, side. The open sachet may preferably be formed by folding a single web and sealing it transversely to the fold at two spaced-apart positions, leaving one edge open.

Filling of the open sachet can be done with a variety of volumetric devices, such as a dosing screw or as a measuring cup. Typical dosing accuracy required at constant product density is +/−1% wt preferably, +/−5% wt minimum.

Filling devices are supplied by the companies mentioned above as part of the machine package.

Feedback control mechanisms acting on the speed of the dosing screw or on the volume of the measuring cup can be installed to maintain high dosing accuracy when the product density changes.

### Sealing

Seal strength is important, as the sachet must not open during the wash cycle or other type of cleaning or water-softening operation, otherwise any water insoluble ingredients might soil the items washed.

A seal strength of at least 5N/20 mm, preferably at least 10N/20 mm and most preferably at least 15N/20 mm according to test method ISO R-527 measured before the wash sealed sachet is subjected to a wash. The strength of any seal is very much dependent on the materials used and the conditions of the sealing process, for example the following conditions are used to generate good quality seals on 100% non woven polypropylene (PP) such as LS3440 by Freudenberg or Berotex PP 40 gsm by BBA or Axar A by Atex
heat sealing, preferably using flat sealing bars, 5 mm by 100 mm, Teflon coated stainless steel, typically 1 sec at 150° C. +/−1° C. at 20 kg/cm² actual sealing pressure, as achieved on a bench scale Kopp heat sealer and on the heat sealing devices of most of the machine suppliers mentioned before;
ultrasound sealing, preferably using grooved sealing bars, 5 mm by 150 mm, pattern with diagonal grooves at 45 degrees to the side of the seal, pitch of 15 mm and bar width of 5 mm with a nominal seal area coverage of 33%, 0.1 to 0.3 s at 20 kHz and 70 microns vibration amplitude, actual sealing pressure between 10 and 60 kg/cm², typical absorbed power 300 to 1200W, typical absorbed energy 30 to 180W, using ultrasound sealing equipment produced by companies like Mecasonic or Branson or Herrmann or Sonic or Dukane or Sonobond.;
glue sealing, e.g. applying 10 g/m² of hot melt glue like Prodas 1400, PP, from Beardow Adams. Polyethylene (PE) or polyamides or polyurethanes or UV curable acrylics glues or epoxy resins can be used as well.

### Cutting the Closed Sachet

Cutting can be achieved through rotary knives, scissors, vibrating blunt knives and lasers.

### Distributing Evenly the Detergent Composition

Distribution of the detergent composition in the sachet can be achieved by the use of customised powder distribution devices based on a combination of vibrating belts and/or pressure rollers.

Typical sources of vibrations are electromagnetic orbital vibrators, rotating eccentric disks and crankshaft mechanisms. Suitable vibration frequencies are between 50 and 2000 Hz, preferably between 200 and 1000 Hz. Suitable vibration amplitudes are between 0.2 and 10 mm, preferably between 1 and 5 mm. Suitable residence times of the sachet between the belts or rollers are between 0.5 and 30 sec, preferably between 2 and 20 sec. Suitable pressures of the sachet between the belts or rollers are between 0.01 and 2 kg/cm², preferably between 0.2 and 1 kg/cm².

### Fixing the Detergent Composition

Preferably, this is achieved by heating the binder, when present, in the composition:
by convective heat, for example by the use of an hot air oven, typical residence times around 90 seconds for 130° C. air may be needed. Pressures of 0.01 to 1 kg/cm², preferably 0.05 to 0.3 kg/cm² facilitate the flow of the binder throughout the product mass;
by conductive heat, for example by the use of a heated pressure belt or belt to drum or drum to drum arrangement, typical residence times between 20 and 40 seconds for 130° C. heating elements, pressure on top of sachet of at least 100 g/cm², preferred 200 g/cm² may be applied also;
by IR heating or UV curing, for selective heating or polymerisation of specific binders, e.g. with 10-30 seconds under an IR radiation with a maximum emission at 2 microns wavelength.

It is possible to perform the step of distributing and fixing at the same time, for example, by the use of heated pressure rollers and/or belts.

A key feature for the selection of the binder, actives and sachet packaging is that:

T_{melting}binder<T_{stability}actives and T_{melting}binder<T_{melting}sachet packaging

Cooling can be used and as is preferably achieved using dry/cool air (T<20° C., RH<50%) resulting in lower sachet temperatures, preferably below 30° C.

### Web Materials

Conventional materials used in tea bag manufacture or in the manufacture of sanitary or diaper products may be suitable, and the techniques used in making tea bags or sanitary products can be applied to make flexible products useful in this invention. Such techniques are described in WO 98/36128, U.S. Pat. No. 6, 093, 474, EP 0708628 and EP 380127A.

Conveniently the web is a non-woven. Processes for manufacturing non-woven fabrics can be grouped into four general categories leading to four main types of non-woven products, textile-related, paper-related, extrusion-polymer processing related and hybrid combinations

### Textiles

Textile technologies include garnetting, carding, and aerodynamic forming of fibres into selectively oriented webs. Fabrics produced by these systems are referred to as drylaid nonwovens, and they carry terms such as garnetted, carded, and airlaid fabrics. Textile-based nonwoven fabrics, or fibre-network structures, are manufactured with machinery designed to manipulate textile fibres in the dry state. Also included in this category are structures formed with filament bundles or tow, and fabrics composed of staple fibres and stitching threads.

In general, textile-technology based processes provide maximum product versatility, since most textile fibres and bonding systems can be utilised.

### Paper

Paper-based technologies include drylaid pulp and wetlaid (modified paper) systems designed to accommodate short synthetic fibers, as well as wood pulp fibres. Fabrics produced by these systems are referred to as drylaid pulp and wetlaid nonwovens. Paper-based nonwoven fabrics are manufactured with machinery designed to manipulate short fibres suspended in fluid.

### Extrusions

Extrusions include spunbond, meltblown, and porous film systems. Fabrics produced by these systems are referred to individually as spunbonded, meltblown, and textured or apertured film nonwovens, or generically as polymer-laid nonwovens. Extrusion-based nonwovens are manufactured with machinery associated with polymer extrusion. In polymer-laid systems, fiber structures simultaneously are formed and manipulated.

### Hybrids

Hybrids include fabric/sheet combining systems, combination systems, and composite systems. Combining systems employs lamination technology or at least one basic nonwoven web formation or consolidation technology to join two or more fabric substrates. Combination systems utilize at least one basic nonwoven web formation element to enhance at least one fabric substrate. Composite systems integrate two or more-basic nonwoven web formation technologies to produce web structures. Hybrid processes combine technology advantages for specific applications.

The wall of the container may itself act as a further means for modifying the water, for example by having the capability of capturing undesired species in the water and/or releasing beneficial species. Thus, the wall material could be of a textile material with ion-capturing and/or ion-releasing properties, for example as described above, such a product may be desired by following the teaching of WO 02/18533 that describes suitable materials.

### Dye Transfer Inhibition Composition

The product may contain one or more dye transfer inhibition agents/dye catchers.

This may be present in the detergenet compspotion. Alternatively this agent may be affixed to or adjoined to one of the webs of the product. Such affixed/adjoioned agents can be used to give a consumer an indication of the working of the product by changing colour in use.

Any suitable dye transfer inhibition agent may be employed. Ideally the dye transfer inhibition agent is water soluble/dispersible in water. Unlike detergents or surfactants, which simply aid in the removal of soils from surfaces, the dye transfer inhibition agents actively binds to the dye allowing it to be removed from the surface of the laundry. Once bound, the dye is less likely to be able to redeposit onto the surface of the laundry. Preferred dye transfer inhibition agents have a high affinity to both oily and water-soluble dyes. Preferably, the dye transfer inhibition agent is a mixture of two or more dye transfer inhibition agents, each dye transfer inhibition agent may have a different affinity for different dyes.

Suitable dye transfer inhibition agents include polymers, such as acrylic polymers, polyesters and polyvinylpyrrolidone (PVP). The polymers may be crosslinked, examples of which include crosslinked acrylic polymers and crosslinked PVP. Super absorbing polymers are mainly acrylic polymers and they are useful for the scope of this patent.

Other important polymers are ethylidene norbene polymers, ethylidene norbene/ethylene copolymers, ethylidene norbene/propylene/ethylidene ter-polymers.

Inorganic materials may also be employed. Examples include silica, silicates (e.g. magnesium silicate), zeolites, talc, bentonites and active carbon. The latter may be used to absorb and/or degrade coloured parts of stain. Alginates, carrageneans and chitosan may also be used. Quaternary ammonium-compounds such as hydroxy-haloalkyl compounds, salts of epoxyalkyl ammonium compounds, poly-quaternary ammonium compounds, polyamphoterics are also suitable. Preferred water insoluble agents are selected from at least one of acrylic polymer, polyester, polyvinylpyrrolidone (PVP), silica, silicate, zeolite, talc, bentonites, active carbon, alginates, carrageneans, ethylidene morbene/propylene/ethylidene ter-polymers and chitosan in the manufacture of a cleaning composition as an active agent for binding soil. Preferably the cleaning composition is a laundry cleaning composition or stain-removing composition.

Preferably, the dye transfer inhibition agent comprises a solid cross-linked polyvinyl N-oxide, or chitosan product or ethylidene norbene/propylene/ethylidene ter-polymers or blend of the same, as discussed more fully hereafter.

### Packaging

Preferably the product is held in a packaging system that provides a moisture barrier.

The packaging may be formed from a sheet of flexible material. Materials suitable for use as a flexible sheet include mono-layer, co-extruded or laminated films. Such films may comprise various components, such as polyethylene, poly-propylene, poly-styrene, poly-ethylene-terephtalate or metallic foils such as aluminium foils. Preferably, the packaging system is composed of a polyethylene and bi-oriented-poly-propylene co-extruded film with an MVTR of less than 30 g/day/m² . The MVTR of the packaging system is preferably of less than 25 g/day/m^{2,} more preferably of less than 22 g/day/m². The film may have various thicknesses. The thickness should typically be between 10 and 150 μm, preferably between 15 and 120 μm, more preferably between 20 and 100 μm, even more preferably between 30 and 80 μm and most preferably between 40 and 70 μm.

Among the methods used to form the packaging over the container are the wrapping methods disclosed in WO92/20593, including flow wrapping or over wrapping. When using such processes, a longitudinal seal is provided, which may be a fin seal or an overlapping seal, after which a first end of the packaging system is closed with a first end seal, followed by closure of the second end with a second end seal. The packaging system may comprise re-closing means as described in WO92/20593. In particular, using a twist, a cold seal or an adhesive is particularly suited. Alternatively the packaging may be in the form of a sealable bag that may contain one or more (greater than ten but less than forty) sachets.

MVTR can be measured according to ASTM Method F372-99, being a standard test method for water vapour transfer rate of flexible barrier materials using an infrared detection technique.

In a preferred water-softening method a product of the invention may be disposed in a clothes washing machine throughout the wash and rinse cycles, for example by being placed in the machine's drum with laundry to be washed.

In a further definition the invention may be stated to be a process for the preparation of a water-softening product, the process comprising
(a) folding a sheet of water-permeable water-insoluble sheet material;
(b) supplying a water-softening composition to the folded sheet, the water-softening composition comprising at least one water-softening agent and a fusible binder;
(c) sealing the open sides of the sheet to form an enclosure containing the water-softening composition;
(d) supplying heat to the enclosures to fuse the binder, and cooling it to form a “cake” of water-softening composition spread across the inside of the interior of the enclosure; and
(e) cutting the sheet or enclosure to form a sachet, the cutting being carried out at any suitable stage of the process.

In a further definition the invention may be stated to be a water-softening product formed by a process as described in the previous paragraph, wherein the sachet is of size in the range 80 to 300 cm², and contains at least 5 g of water-softening composition, and wherein the cake breaks in use creating loose granular insoluble materials that can move freely inside the sachet.

A product may be disposed in a clothes washing machine throughout the wash and rinse cycles, for example by being placed in the machine's drum with laundry to be washed.

In this specification percentage values, indicated by the symbols % or % wt, denote weight of the stated component expressed as a percentage of the total composition weight unless otherwise stated.

1. A detergent product comprising a container containing a detergent composition, the container being formed by the closing of a sachet formed from a water permeable water insoluble web, characterised in that the sachet comprises a flexible body of at least 10 mm in one dimension and 10 mm in another direction.

2. A product according to claim 1, wherein the body comprises polypropylene, polyester or PE/EVA.

3. A product according to claim 1, wherein the body comprises a number of separate elements each being formed of a different material.

4. A product according to claim 1, wherein the body comprises an indication means which serves to show the extent of performance of the detergent function.

5. A product according to claim 1, wherein the detergent is a water-softening composition.

6. A product according to claim 1, wherein the detergent is a stain treating composition

7. A process for the preparation of a product according to claim 1, the process comprising the steps of:
a) forming an open sachet from one, two or more water-permeable water-insoluble web;
b) filling the open sachet with a detergent composition; and
c) sealing the sachet.

8. A process according to claim 7, wherein the process includes the further step of:
cutting the web(s) to form the open or closed sachet.

9. A method of softening water comprising the steps of:
providing a product according to claim 5 and contacting hard water with the product.

10. A method of softening water according to claim 9 wherein the hard water is present in a ware washing machine.
